(19) United States
(12) Patent Application Publication
(10) Pub. No.: US 2013/0054578 A1
(43) Pub. Date: Feb. 28, 2013

(54) TEXT SEARCH APPARATUS AND TEXT SEARCH METHOD

(71) Applicant: Katsuhiko Satoh, Hachioji-shi (JP)

(72) Inventor: Katsuhiko Satoh, Hachioji-shi (JP)

(73) Assignee: CASIO COMPUTER CO., LTD., Tokyo (JP)

(21) Appl. No.: 13/597,406

(22) Filed: Aug. 29, 2012

(30) Foreign Application Priority Data
Aug. 31, 2011 (JP) 2011-189260

(51) Int. Cl. G06F 17/30

(52) U.S. Cl. 707/722; 707/E17.061

(57) ABSTRACT

A text search apparatus includes: a memory storing a plurality of sets of text data, text data of each set including a plurality of categories; an obtainer obtaining a search keyword; a retriever retrieving text data including the obtained search keyword for each category from the text data stored in the memory; and an output unit determining an order of the text data retrieved by the retriever by an order determining method which is preliminarily determined according to a category, and outputting the data by categories.

### CROSS-REFERENCE TO RELATED APPLICATION

This application claims the benefit of Japanese Patent Application No. 2011-189260, filed Aug. 31, 2011, the entire disclosure of which is incorporated by reference herein.

### FIELD

The present invention relates to a text search apparatus and a text search method.

### BACKGROUND

As described in Unexamined Japanese Patent Application KOKAI Publication No. H10-049549, there is a conventionally known document search apparatus having a memory storing a document to be retrieved, a field constructing the document, and a word written in the field of the document so as to be associated with one another and, when a search keyword is obtained, determining the degree of preferential display of the document associated with the word matching the keyword on the basis of the field associated with the word.

For example, in the case where the document is an electronic dictionary, the document has category fields (hereinafter, simply referred to categories) such as an entry word in which texts expressing entry words are sorted, a comment part in which texts expressing comments of entry words are sorted, and a use example part in which texts expressing use examples of the entry words are sorted. In such a case, the document search apparatus described in the background art cannot retrieve texts sorted in the plurality of categories of the document by the categories on the basis of a search keyword. If a plurality of texts searched in the respective categories are not displayed in the order determined according to the contents expressed by the texts, when the number of texts retrieved increases, there is a problem such that it becomes difficult for the user to find a desired piece of text.

The present invention has been achieved in view of such points and an object of the invention is to provide a text search apparatus and a text search method capable of retrieving texts sorted in a plurality of categories on the basis of a search keyword but also rearranging search results by a method according to the categories and outputting the rearranged search results.

### SUMMARY

To achieve the object, a text search apparatus comprises:

a memory storing a plurality of sets of text data, the text data of each set including a plurality of categories (category fields);

an obtainer obtaining a search keyword;

a retriever retrieving, for each category, text data including the obtained search keyword, from the text data stored in the memory; and

an output unit determining an order of outputting of the text data retrieved by the retriever with using an order determining method which is preliminarily determined in accordance with the category and outputting the retrieved text data category by category.

According to the present invention, texts sorted in a plurality of categories can be retrieved on the basis of a search keyword, moreover, search results can be rearranged by a method according to each of the categories, and the rearranged search results can be output.

### BRIEF DESCRIPTION OF THE DRAWINGS

A more complete understanding of this application can be obtained when the following detailed description is considered in conjunction with the following drawings, in which:

FIG. 1 is a perspective view showing an example of a text search apparatus according to an embodiment of the present invention;

FIG. 2 is a hardware configuration diagram showing a configuration example of the text search apparatus;

FIG. 3 is a flowchart showing an example of a process of generating data and the like, executed by the text search apparatus;

FIG. 4 is a functional block diagram showing an example of functions of the text search apparatus;

FIG. 5A is a diagram showing an example of dictionary data stored in the text search apparatus, and FIG. 5B is a diagram showing an example of rearranged content text data stored in the text search apparatus;

FIG. 6 is a diagram showing an example of a dictionary table stored in the text search apparatus;

FIG. 7 is a diagram showing an example of an electronic file stored in the text search apparatus;

FIG. 8 is a flowchart showing an example of a text retrieval process executed by the text search apparatus according to the embodiment;

FIG. 9 is a flowchart showing an example of a single-character-string retrieval process executed by the text search apparatus;

FIG. 10 is a diagram showing an example of a determining method table stored in the text search apparatus according to the embodiment;

FIG. 11 is a diagram showing an example of a search result display screen displayed by the text search apparatus;

FIG. 12 shows a first half part of a flowchart showing an example of a plural-character-string retrieval process executed by the text search apparatus;

FIG. 13 shows a latter half part of the flowchart showing an example of the plural-character-string retrieval process executed by the text search apparatus;

FIG. 14 is a flowchart showing an example of a first noted verification character string appearance position specifying process executed by the text search apparatus;

FIG. 15 is a flowchart showing an example of a second noted verification character string appearance position specifying process executed by the text search apparatus;

FIG. 16A is a diagram showing an example of the distance between a verification character string and a reference character string in the case where a specified appearance position of the verification character string is after a specified appearance position of the reference character string, and FIG. 16B is a diagram showing an example of the distance between a verification character string and a reference character string in the case where the specified appearance position of the verification character string is before the specified appearance position of the reference character string;

FIG. 17 is a diagram showing an example of the minimum and maximum values of a minimum inclusion range of a search keyword;

FIG. 18 is a diagram showing an example of use example texts displayed by the text search apparatus according to the embodiment;

FIG. 19 is a flowchart showing an example of a text retrieval process executed by a text search apparatus according to a first modification of the embodiment;

FIG. 20 is a diagram showing an example of a determining method table stored in the text search apparatus according to the first modification of the embodiment;

FIG. 21 is a diagram showing an example of use example texts displayed by the text search apparatus according to the first modification of the embodiment; and

FIG. 22 is a diagram showing an example of use example texts displayed by a text search apparatus according to a second modification of the embodiment.

### DETAILED DESCRIPTION

Hereinafter, a text search apparatus 100 according to an embodiment of the present invention will be described with reference to the appended drawings.

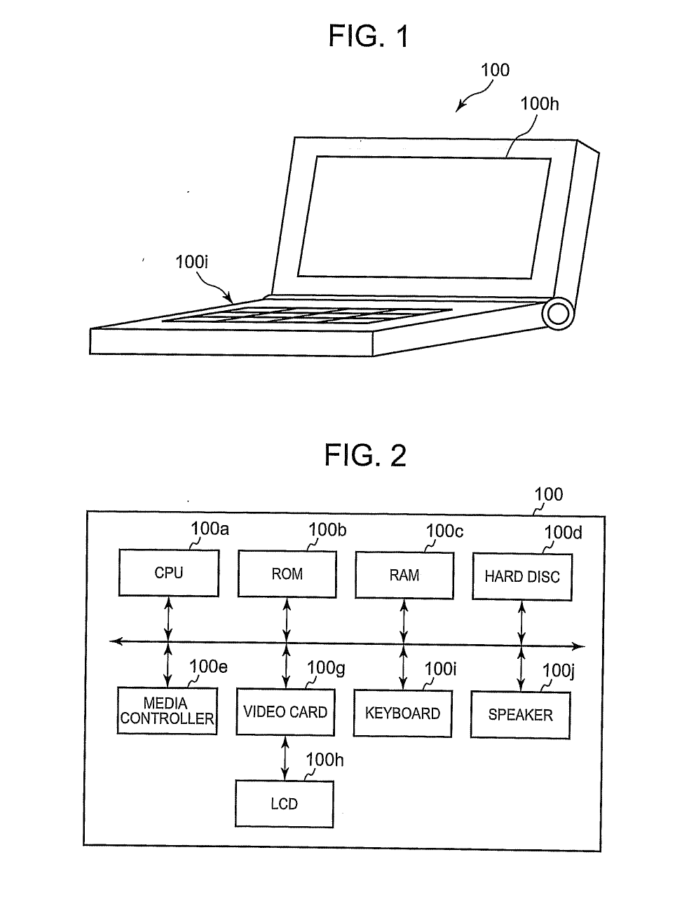

The text search apparatus 100 according to the embodiment is incorporated in an electronic dictionary as shown in FIG. 1. The text search apparatus 100 has a keyboard 100i by which a search keyword is entered; and an LCD (Liquid Crystal Display) 100h displaying a result of a search made on a dictionary on the basis of a search keyword.

The text search apparatus 100 has therein a CPU (Central Processing Unit) 100a, a ROM (Read Only Memory) 100b, a RAM (Random Access Memory) 100c, a hard disk (drive) 100d, a media controller 100e, a video card 100g, and a speaker 100j as shown in FIG. 2 and connected to the LCD 100h and the keyboard 100i via a bus.

The CPU 100a executes software process in accordance with a program stored in the ROM 100b or the hard disk 100d, thereby performing general control of the text search apparatus 100. The RAM 100c temporarily stores data to be processed at the time of executing the program by the CPU 100a.

The hard disk 100d stores a table storing various data, and dictionary data indicative of an English-Japanese dictionary and the like. The text search apparatus 100 may have a flash memory instead of the hard disk 100d.

The media controller 100e reads various data and programs from recording media including a flash memory, a CD (Compact Disc), a DVD (Digital Versatile Disc), and a Blu-ray disc (registered trademark).

The video card 100g renders an image on the basis of a digital signal output from the CPU 100a and outputs an image signal indicative of the drawn image. The LCD 100h displays an image in accordance with the image signal output from the video card 100g. The text search apparatus 100 may have a PDP (Plasma Display Panel) or EL (Electroluminescence) display in place of the LCD 100h. The speaker 100j outputs voice on the basis of the signal output from the CPU 100a.

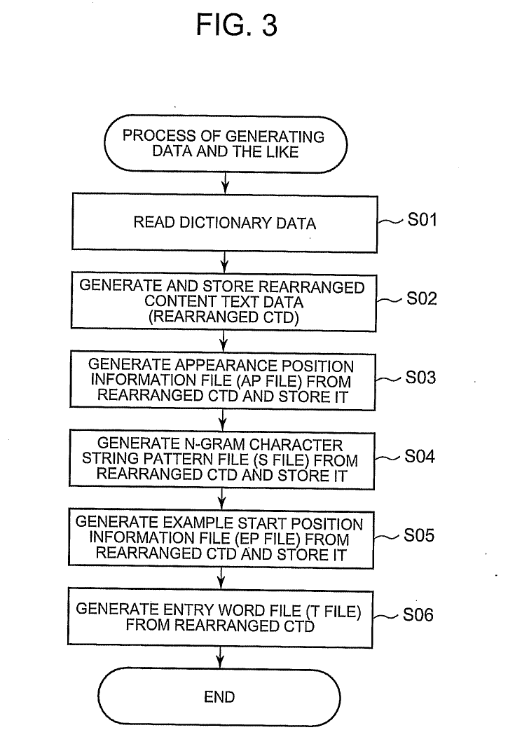

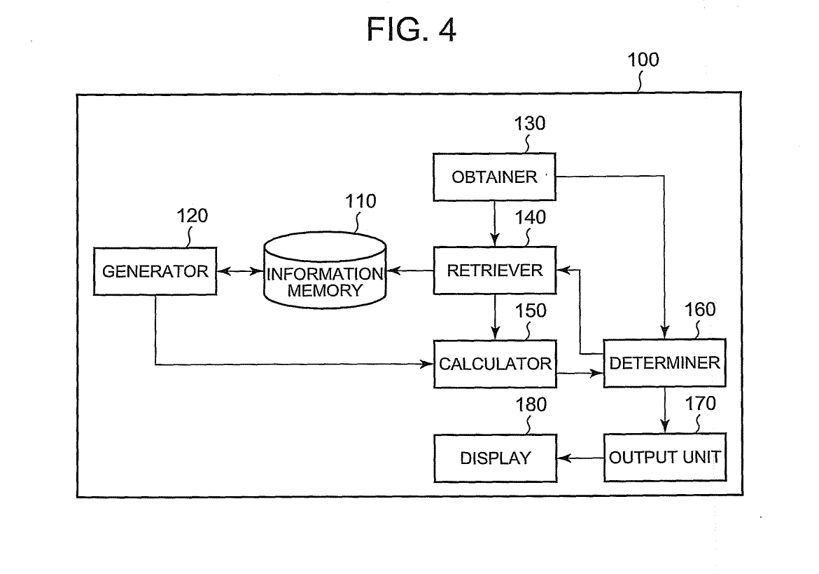

When the user purchases a recording medium in which dictionary data is recorded and inserts the recording medium into the media controller 100e shown in FIG. 2, the CPU 100a receives a predetermined signal from the media controller 100e. Subsequently, the CPU 100a obtains the dictionary data from the media controller 100e and stores it in the hard disc 100d. After that, the CPU 100a executes a data generating process as shown in FIG. 3 of generating data and an electronic file used for retrieving a dictionary expressed by the dictionary data on the basis of a search keyword. Consequently, the CPU 100a functions as a generator 120 as shown in FIG. 4. The CPU 100a and the hard disk 100d cooperate to serve as an image memory 110.

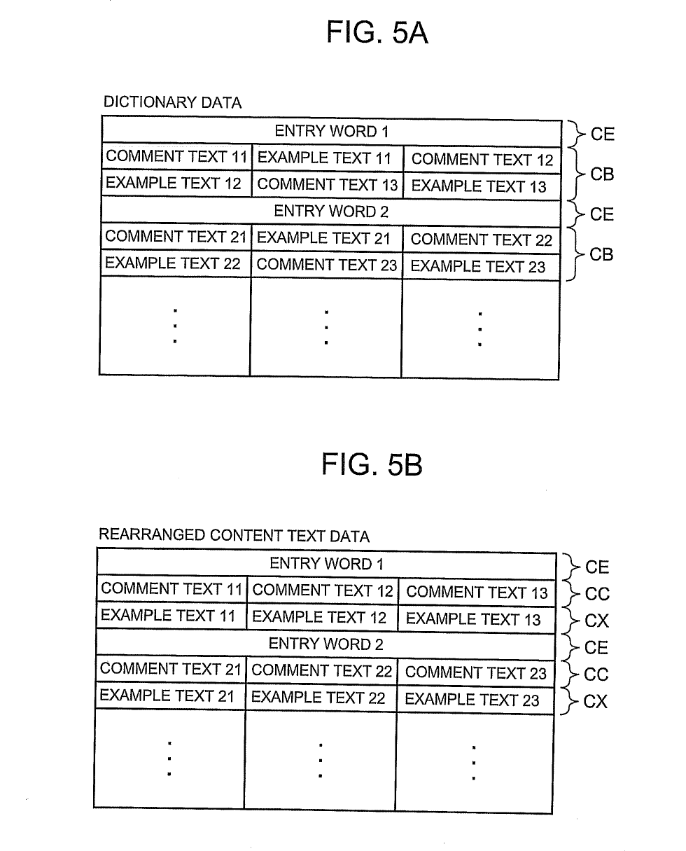

When the data generating process shown in FIG. 3 is started, the generator 120 reads dictionary data indicative of dictionary content stored in the information memory 110 (step S01). As shown in FIG. 5A, the dictionary data is constructed by a plurality of entry words (entry parts) CE and text parts CB made by comments on the entry word CE and examples of the entry word CE. A comment text is put between a pair of comment tags indicating that content expressed by the text is a comment, and an example text is put between a pair of example tags indicating that content expressed by the text is an example.

The entry words CE are arranged in alphabetical order. Immediately after each of the entry words CE, respective text part CB including a comment text(s) and an example text(s) of the entry word CE is arranged. To the entry word CE, an entry word number (Identifier) for identifying the entry word CE is assigned in advance. Further, the dictionary data includes a plurality of pieces of information in which information expressing an entry word number, information indicative of the start (initial) address of a storage region in the information memory 110 in which the entry word CE identified by the entry number is stored, and information indicative of the start address of a text part CB stored immediately after the entry word CE is associated.

The arrangement order of comment texts is according to an arrangement order determined by the editor of the electronic dictionary. A comment text describing a more common meaning of the entry word may be stored in a position before a comment text that describes a more special meaning of the entry word, or a comment text describing a meaning that is more frequently used may be stored in a position before a comment text describing a meaning which is less frequently used.

Since comment texts and example texts exist mixedly in the text part CB, the generator 120 sorts the texts in accordance with the contents. For the sorting, the generator 120 extracts a plurality of entry word texts and body texts from the dictionary data by using the information indicative of the entry word number included in the dictionary data and the information indicative of the head address of the text part CB. The generator 120 also extracts, for each extracted entry word text, a plurality of comment texts describing the entry word CE expressed by the entry word text from the body text on the basis of a comment tag and extracts a plurality of example texts expressing an example use of the entry word on the basis of the example tag.

After that, as shown in FIG. 5B, for each of the extracted entry word texts, the generator 120 generates a category (hereinafter, called a comment part) CC in which the extracted plurality of comment texts are sorted by changing arrangement without changing the original arrangement order of the extracted plurality of comment texts. Similarly, for each of the extracted entry word texts, the generator 120 generates a category (hereinafter, called an example part) CX in which the extracted plurality of example texts are sorted by changing arrangement without changing the original arrangement order of the extracted plurality of example texts.

Data constructed by a plurality of pieces of data obtained by associating the entry word CE, the comment part CC, and the example part CX generated as described above with one another is called rearranged content text data (or rearranged CDT). Subsequently, the generator 120 stores the rearranged content text data into the information memory 110 (step S02 in FIG. 3).

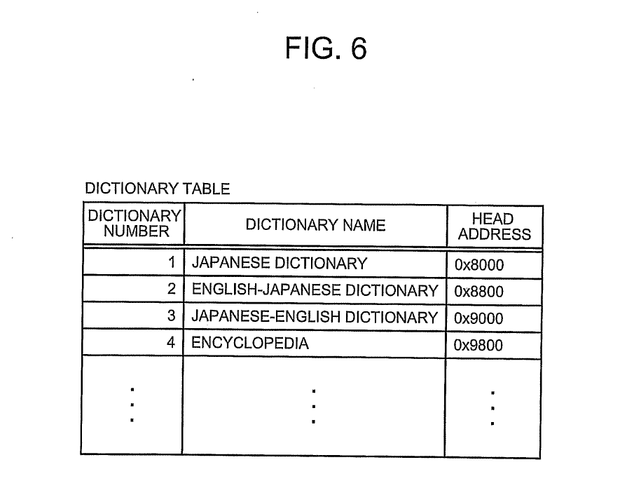

After that, the generator 120 generates a dictionary number for identifying a dictionary expressed by the rearranged content text data. The generator 120 stores information obtained by associating information expressing the generated dictionary number, information indicative of the name of the dictionary, and information indicative of the head address of a storage region in the information memory 110 in which the rearranged content text data is stored with one another into a dictionary table shown in FIG. 6. The dictionary table is stored in the information memory 110.

Subsequently, the generator 120 extracts a monogram character string pattern by cutting out one character while shifting characters one by one from the head of a text expressed by the rearranged content text data (that is, texts sorted in the entry word CE, the comment part CC, and the example part CX). Similarly, the generator 120 extracts a bigram (aka digraph) character string pattern by cutting out two characters while shifting characters one by one from the head of a text expressed by the rearranged content text data. Hereinafter, the monogram character string pattern and the bigram character string pattern will be collectively called an N-gram character string pattern. In the embodiment, it is assumed that a character is included in a character string, and a character and a character string are not distinguished unless otherwise described.

The generator 120 specifies one or plural positions in which an N-gram character string pattern appears in a text expressed by rearranged content text data (hereinafter, called rearranged text) for each of the N-gram character string patterns. After that, for each of the N-gram character string patterns, the generator 120 calculates the frequency of appearance of the N-gram character string pattern in the rearranged text for each of the N-gram character string patterns. Although the appearance frequency will be described as, for example, total number of times the N-gram character string pattern appears in a rearranged text, the invention is not limited to the total number.

The generator 120 generates appearance position information obtained by associating one or plural information expressing an address indicative of an appearance position in which the N-gram character string pattern appears (hereinafter, called an appearance position address) for each of the N-gram character string patterns and an appearance frequency of them.

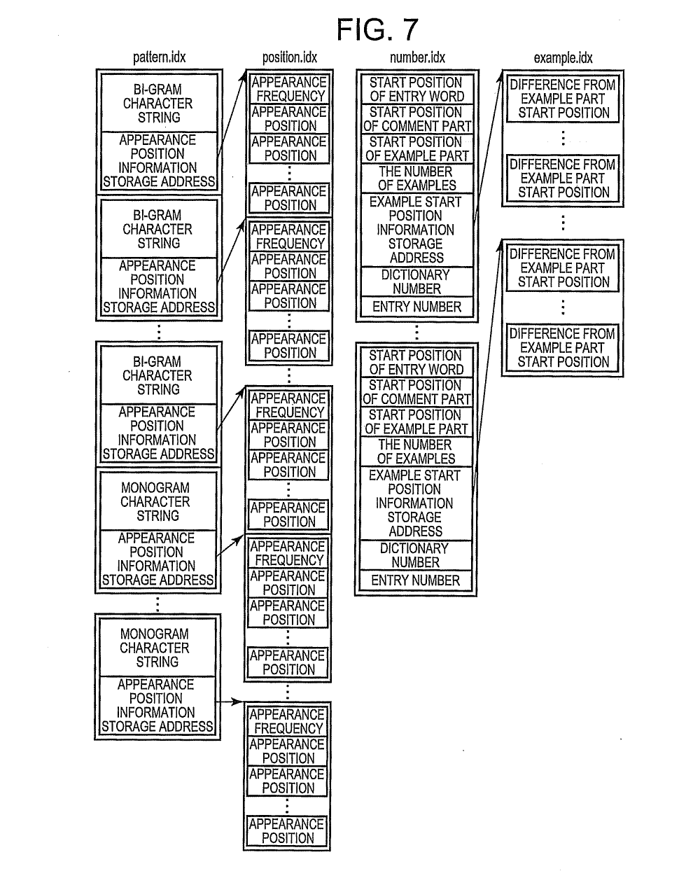

The generator 120 generates an electronic file including one or plural appearance position information (hereinafter, called an appearance position information file or an AP file) as shown in FIG. 7, gives name “position.idx” to the appearance position information file, and stores the resultant to the information memory 110 (step S03 shown in FIG. 3). With respect to the appearance position information stored in the appearance position information file, information expressing the appearance frequency is stored in a region of predetermined number of bytes for appearance frequency from the head address, and information expressing the appearance position address is stored every predetermined number of bytes for the appearance position immediately after the region.

The generator 120 generates an electronic file (hereinafter, called an N-gram character string pattern file or an S file) including a plurality of pieces of information obtained by associating information expressing an N-gram character string pattern (hereinafter, called N-gram character string pattern information) and information expressing a head address of a storage region in the information memory 110 in which information of an appearance position of the N-gram character string pattern is stored (hereinafter, called an appearance position information memory address). After that, the generator 120 gives name “pattern.idx” as shown in FIG. 7 to the N-gram character string pattern file and stores the file in the information memory 110 (step S04).

The generator 120 calculates the difference between the head address of the example part CX and the head address of the example text (hereinafter, called a difference from an example part start position) for each of entry words by the number of example texts sorted in the example part CX (hereinafter, called the number of examples). Subsequently, the generator 120 generates example start position information made by information expressing the difference from one or plural example part start positions for each of the entry words, and generates an electronic file (hereinafter, called an example start position information file or an EP file) including a plurality of pieces of the generated example start position information. After that, the generator 120 gives name “example.idx” as shown in FIG. 7 to the example start position information file, and stores the file in the information memory 110 (step S05 in FIG. 3). As the example start position information stored in the EP file, information indicative of the difference from the example part start position is stored in a region of predetermined number of bytes of the difference from the head address, and information indicative of another difference is stored every predetermined number of bytes immediately subsequent to the region.

Next, the generator 120 generates an electronic file (hereinafter, called an entry word file or a T (Title) file) including a plurality of pieces of information obtained by associating entry word number for identifying the entry word CE in which entry word texts are sorted, information indicative of the head address (hereinafter, called an address expressing the start position of the entry word CE) of the storage region in the information memory 110 in which the entry word CE is stored, information expressing the head address of the comment part CC (hereinafter, called an address expressing the start position of the comment part CC) in which the comment text describing the entry word expressed by the entry word text is sorted, information indicative of the head address of the example part CX (hereinafter, called the address expressing the start position of the example part CX) in which the example text expressing an example of the entry word is sorted, information expressing the number of examples in the example part CX, information indicative of an address expressing the head position of the region in the information memory 110, in which the example part start position information of the example part CX is stored (hereinafter, called an example part start position information memory address), and information expressing the dictionary number of the dictionary having the entry word. After that, the generator 120 gives name “number.idx” as shown in FIG. 7 to an entry word file, stores the resultant file to the information memory 110 (step S06 in FIG. 3), and finishes execution of the data generating process. An electronic file generated by the data process is used for a full-text search with a search keyword.

Next, a dictionary searching operation will be described.

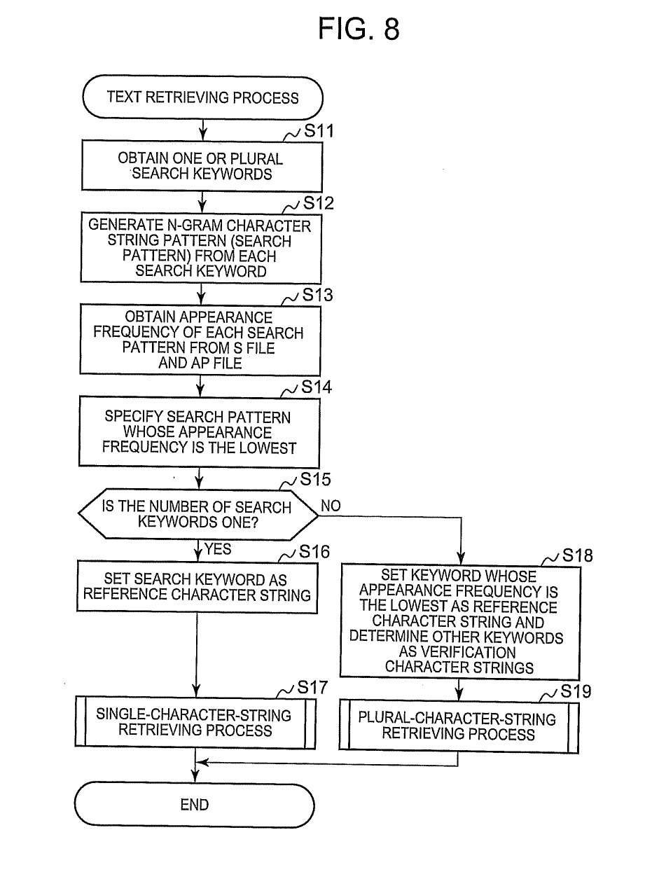

When the user operates the keyboard 100i to enter a search keyword and a search instruction used for searching a dictionary, the CPU 100a receives signals or information according to the operation from the keyboard 100i. Next, the CPU 100a executes a text retrieval process shown in FIG. 8, thereby functioning as an obtainer 130, a retriever 140, a calculator 150, a determiner 160, and an output unit 170 as shown in FIG. 4. The CPU 100a also functions as a display 180 in cooperation with the video card 100g and the LCD 100h shown in FIG. 2.

When execution of the text retrieval process shown in FIG. 8 is started, the obtainer 130 shown in FIG. 4 obtains one or plural search keywords (step S11) and obtains a search instruction.

Hereinafter, the case where a search keyword “while” is obtained will be described as an example.

The retriever 140 generates an N-gram character string pattern from the search keyword “while” and sets the generated N-gram character string pattern as a search pattern (step S12). In the case where the search keyword is made by one character, the retriever 140 generates a monogram character string pattern as a search pattern. In this case, since the search keyword “while” is constructed by characters more than one character, the retriever 140 generates bigram character string patterns “wh”, “hi”, “il”, and “le” as search patterns.

Next, the retriever 140 obtains the appearance frequency of each search pattern from an AP file (that is, appearance position information file) and an S file (that is, N-gram character string pattern file) (step S13 shown in FIG. 8). Concretely, the retriever 140 obtains an appearance position information memory address from an N-gram character string pattern file whose file name shown in FIG. 7 is “pattern.idx”, and extracts the appearance frequency in accordance with a position indicated by the obtained appearance position information memory address from an appearance position information file whose file name shown in FIG. 7 is “position.idx”.

After that, the retriever 140 specifies a search pattern whose appearance frequency is the lowest among the search patterns “wh”, “hi”, “il”, and “le” generated in step S12 (step S14 shown in FIG. 8). When the search keyword is retrieved from the dictionary on the basis of the search pattern whose appearance frequency is the lowest, the text retrieval process is finished in shorter time as compared with the case of searching the dictionary on the basis of the search pattern whose appearance frequency is higher. It is assumed here that the appearance frequency of “il” is the lowest.

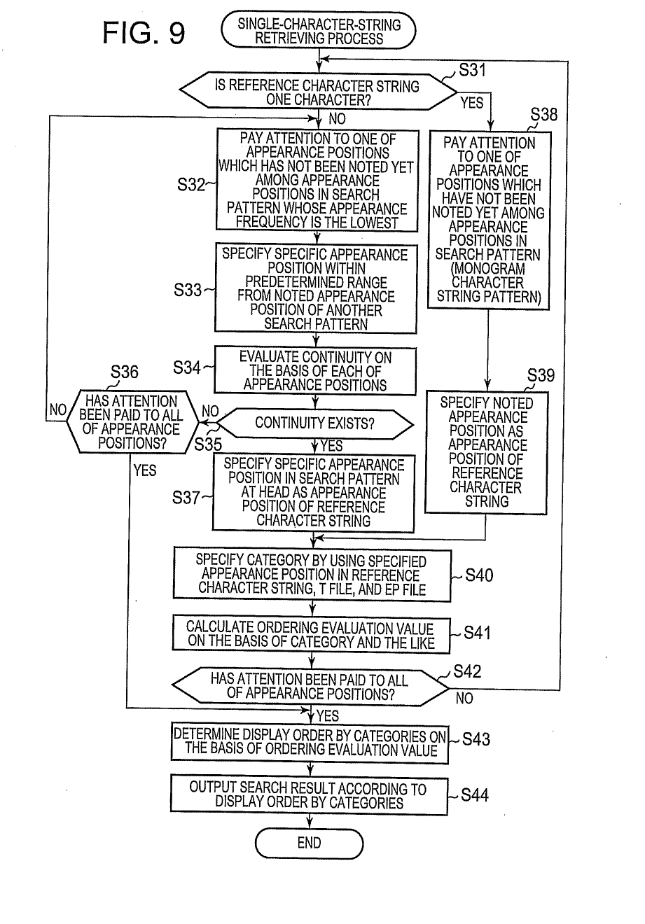

The retriever 140 determines that the obtained search keyword is one search keyword “while” (Yes in step S15) and sets the search keyword as a reference character string (step S16). Next, the retriever 140 executes a single-character-string retrieval process as shown in FIG. 9 of searching the electronic dictionary on the basis of the single character string “while” (step S17 shown in FIG. 8) and finishes the text retrieval process.

When execution of the single-character-string retrieval process shown in FIG. 9 is started, the retriever 140 determines that the reference character string “while” used for a search is not one character (No in step S31). Next, the retriever 140 obtains a plurality of appearance positions of search patterns for each search pattern.

After that, the retriever 140 pays attention to an appearance position which has not been noted yet among the appearance positions of the search pattern “il” whose appearance frequency is the lowest, which is specified in step S14 shown in FIG. 8 (step S32). The retriever 140 sets the appearance position to which attention is paid as a noted appearance position and sets a search pattern which appears in the noted appearance position as a noted search pattern.

After that, the retriever 140 specifies appearance positions existing in a predetermined range from the noted appearance position within appearance positions of the search patterns “wh”, “hi”, and “le” except for the noted search pattern “il” and sets the specified appearance position as a specified appearance position (step S33).

Next, the retriever 140 evaluates continuity of the specified appearance position of the search pattern “wh”, the specified appearance position of the search pattern “hi”, the noted appearance position of the noted search pattern “il”, and the specified appearance position of the search pattern “le” (step S34). Concretely, the retriever 140 determines whether the number of characters from the search pattern in the reference character string (that is, the search keyword) to the noted search pattern and the number of characters from the specified appearance position of the search pattern to the noted appearance position of the noted search pattern are the same or not with respect to each of the search patterns. In the case where the number of characters from the search pattern to the noted search pattern and the number of characters from the specified appearance position to the noted appearance position coincide with respect to all of the search patterns, presence of continuity is determined. In contrast, in the case where the number of characters from the search pattern to the noted search pattern and the number of characters from the specified appearance position to the noted appearance position are different in any one of the search patterns, absence of continuity is determined.

When the continuity evaluation result is absence of continuity (No in step S35), the retriever 140 determines whether attention has been paid to all of the appearance positions of the search pattern “il” whose appearance frequency is the lowest or not (step S36). When it is determined that attention has not been paid to all of the appearance positions of the search pattern “il” whose appearance frequency is the lowest (No in step S36), the processes are repeated from step S32. When it is determined that attention has been paid to all of the appearance positions of the search pattern “il” whose appearance frequency is the lowest (Yes in step S36), the retriever 140 advances to step S43.

When the processes in steps S32 to S34 are executed and it is determined in step S35 that the continuity evaluation result is presence of continuity (Yes in step S35), the retriever 140 specifies the specified appearance position of the search pattern “wh” at the head of the search patterns constructing the reference character string “while” as the appearance position in which the reference character string “while” appears in the rearranged text (step S37).

When it is determined in step S31 that the reference character string used for the search is one character (Yes in step S31), the retriever 140 pays attention to an appearance position which has not been noted yet among the appearance positions in the search pattern (that is, the monogram character string pattern) generated in step S12 shown in FIG. 8 (step S38 in FIG. 9) and sets the appearance position as the specified appearance position in the reference character string (step S39).

After step S37 (or step S39), the retriever 140 specifies a category (any of the entry word CE, the comment part CC, and the example part CX) in which a text in the specified appearance position (hereinafter, called a specified text) is sorted on the basis of an entry word file (T file) having the file name “number.idx”, an example start position information file (EP file) having the file name “example.idx”, and the specified appearance position of the reference character string “while” shown in FIG. 7 (step S40).

Concretely, the retriever 140 specifies an entry word CE starting from a closest address before the specified appearance position of the reference character string “while”, retrieves an address indicating the start position of the specified entry word CE, an address indicating the start position of the comment part CC corresponding to the entry word, and an address indicating the start position of the example part CX corresponding to the specified entry word from the entry word file having the file name “number.idx”, and examins the positional relations between the addresses and an address indicating the specified appearance position of the reference character string “while”, thereby specifying that the specified text is the entry word CE, the comment part CC, or the example part CX.

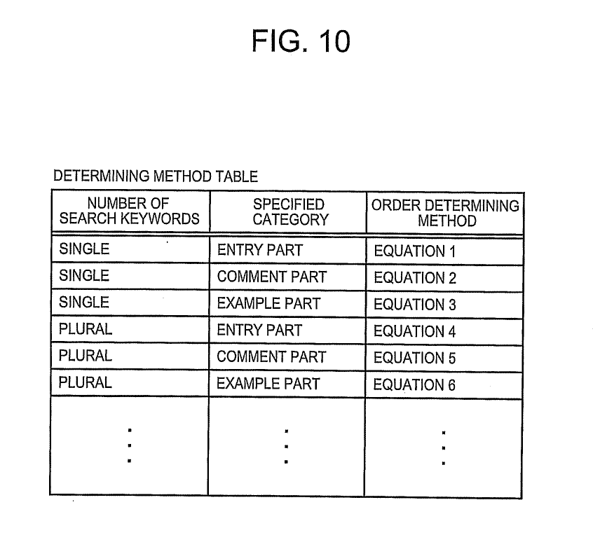

Next, the retriever 140 retrieves a determining method of determining the order of display from a specified text on the basis of the number of search keywords and the category in which the specified text is sorted from a determining method table shown in FIG. 10. The determining method table is pre-stored in the information memory 110. The calculator 150 shown in FIG. 4 calculates an evaluation value of the specified text used for determining the display order by using the order determining method expressed by the retrieved information (step S41). The lower the evaluation value is, the higher the possibility that the text is desired by the user is.

Concretely, in the case where the category in which the specified text is sorted (hereinafter, called specified category) is the entry word CE, the retriever 140 retrieves information expressing the order determining method “equation 1” associated with information indicating that the search keyword is “single” and information indicating the specified category “entry word” from the determining method table shown in FIG. 10.

Next, the calculator 150 calculates the number of characters of the specified text and sets the calculated number of characters as the number of characters of the specified entry word. The calculator 150 also calculates the number of characters of the reference character string “while”. Subsequently, the calculator 150 calculates an evaluation value of the specified text by using the number of characters of the specified entry word and the number of characters of the reference character string “while” for the following equation (1).

$${Est}_{idxid , cgy} = {Est}_{idxid , 0} = \frac{{NumStr}_{index}}{{NumStr}_{stdstr}} \qquad ( 1 )$$

where
idxid: entry number
cgy: category number (0: entry word CE, 1: comment part CC, 2: example part CX)
Est_{idxid,cgy}: evaluation value of specified text of category number cgy corresponding to specified entry word having remark number idxid
Est_{idxid,0}: evaluation value of specified text of specified entry word having entry number idxid
NumStr_{index}: the number of characters of entry word
NumStr_{stdstr}: the number of characters of reference character string

The evaluation value calculated by the equation (1) becomes the minimum value in the case where the reference character string “while” and the character string of the specified entry word (that is, the entry text) coincide with each other, and becomes a larger value the more the characters except for the reference character string “while” are included in the entry text of the specified entry word. The reason is that the user usually desires display of the entry text which perfectly matches the reference character string as the search keyword. Usually, the user also desires display of the entry text including the fewest number of characters except for the search keyword than the entry text including a greater number of characters other than the search keyword.

For example, in the case where the specified category is the comment part CC, the retriever 140 retrieves information expressing the order determining method “equation 2” associated with information indicating that the search keyword is “single” and information indicating the specified category “comment part” from the determining method table shown in FIG. 10.

In this case, the calculator 150 calculates an evaluation value of the specified text by using the specified appearance position of the reference character string “while” and the start position of the comment part CC corresponding to the specified entry word as the position expressed by the information retrieved in step S40 shown in FIG. 9 for the following equation (2).

Est_{idxid,cgy}=Est_{idxid,1}=Pos_{stdstr}−PosSt_{idxid,comentary} (2)

where
ESt_{idxid,cgy}: evaluation value of specified text of comment part CC corresponding to specified entry word having entry number idxid
Pos_{stdstr}: specified appearance position of reference character string
PosSt_{idsid,comentary}: start position of comment part CC corresponding to specified entry word of entry number idxid

The lower the evaluation value calculated by the equation (2) is, the closer the specified appearance position of the reference character string “while” becomes to the start position of the comment part CC. The comment text sorted in the comment part CC of the rearranged content text data shown in FIG. 5B is stored, for example, in the position ahead of the comment text describing general content of an entry or content of higher use frequency of an entry. Usually, the user often desires display of a text of general comment or high use frequency, so that priority is placed on a text in which the reference character string exists in a forward position in the comment part CC.

Further, for example, in the case where the specified category is the example part CX, the retriever 140 retrieves information expressing the order determining method “equation (3)” associated with the information indicating that the search keyboard is “single” and information expressing the specified category “example unit” from the determining method table shown in FIG. 10.

In this case, the retriever 140 calculates the difference between the start position of the example part CX and the specified appearance position of the reference character string “while”. After that, the retriever 140 retrieves example start position information from an EP file (that is, example start position information file) having the file name “example.idx” shown in FIG. 7 on the basis of the example start position information memory address expressed by the information retrieved in step S40. The retriever 140 retrieves the largest difference which is equal to or less than the difference between the start position of the example part CX calculated and the specified appearance position of the reference character string “while” from information indicating the difference from the example part start position included in the example start position information. The retriever 140 specifies the number of the retrieved information indicating the difference on the basis of the number of predetermined bytes for the difference and sets the specified number as an example number.

After that, the calculator 150 calculates the start position of the example text having the specified example number by adding the difference expressed by the retrieved information to the start position of the example part CX corresponding to the specified entry word. The calculator 150 calculates the evaluation value of the specified text by using the calculated start position of the example text and the specified appearance position of the reference character string “while” to the following equation (3).

Est_{idxid,cgy}=Est_{idxid,2}=Pos_{stdstr}−PosSt_{idxid,example,expid} (3)

where
Est_{idxid,2}: evaluation value of specified text of example part CE corresponding to specified entry word having entry number idxid
PosSt_{idxid,example,expid}: start position of text having example number expid corresponding to specified entry word of entry number idxid

The lower the evaluation value calculated by the equation (3) is, the closer the specified appearance position of the reference character string “while” is to the start position of the example text. For example, in the case where a plurality of example texts each including the reference character string “while” are sorted in the same example part CX, the evaluation value becomes lower as the position in which the reference character string “while” is used is closer to the front, not whether the storage position in the example part CX is in front or in the rear.

Since an example of general meaning or an example of meaning whose use frequency is higher is usually described in a first position in a dictionary, in the evaluating method, priority may be placed on a small difference between the start position of the example part CX and the specified appearance position of the reference character string.

After step S41 shown in FIG. 9, the retriever 140 determines whether attention has been paid to all of the appearance positions or not (step S42). In the case where the retriever 140 determines that attention has not been paid to all of the appearance positions (No in step S42), the processes from step S31 are repeated.

After the processes from step S31 are repeated, when the retriever 140 determines in step S42 (or step S36) that attention has been paid to all of the appearance positions (Yes in step S36 or S42), the determiner 160 shown in FIG. 4 determines the display order of one or plural specified texts on the basis of the evaluation value of the specified text calculated in step S41 for each category in which the specified text is sorted (step S43). In the embodiment, the determiner 160 determines, as the display order of the specified text, ascending order of the evaluation value of the specified text.

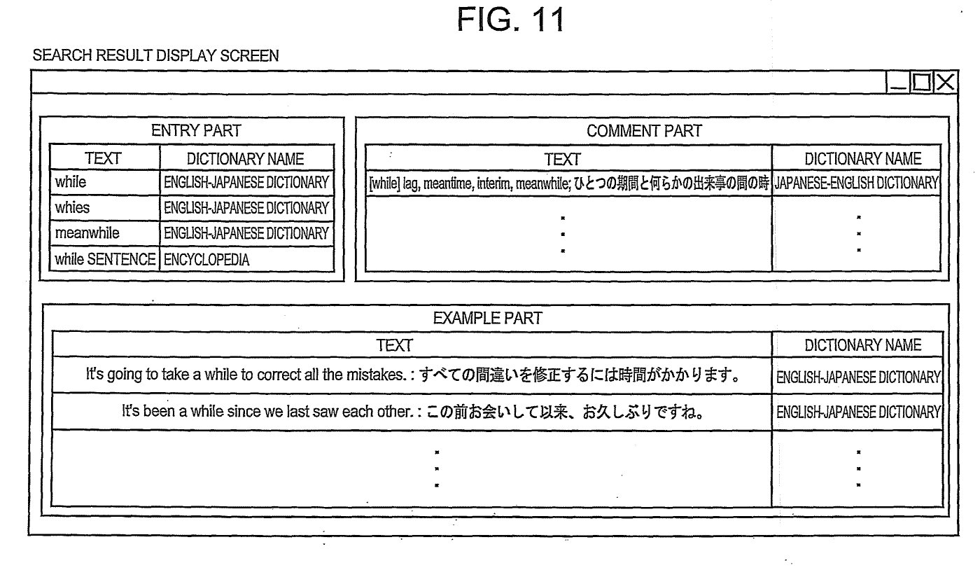

After that, the output unit 170 shown in FIG. 4 outputs a signal indicative of a search result display screen as shown in FIG. 11, displaying one or plural specified texts in the determined display order category by category (step S44 shown in FIG. 9). The display 180 displays a search result display screen on the basis of the output signal. After that, execution of the single-character-string retrieval process is finished.

Next, using the case where three search keywords “for”, “a”, and “while” are input in order as an example, the text retrieval process shown in FIG. 8 will be described.

When execution of the text retrieval process is started, the obtainer 130 obtains the three search keywords “for”, “a”, and “while” in order (step S11). For the search keywords “for” and “while” made by more than one character, the retriever 140 generates search patterns “fo” and “or” and search patterns “wh”, “hi”, “il”, and “le” as bi-gram character string patterns. For the search keyword “a” made of one character, the retriever 140 also generates a search pattern “a” as a monogram character string pattern (step S12).

Next, the retriever 140 obtains the appearance frequency of each of the search patterns (step S13). The retriever 140 specifies a search pattern associated with the lowest appearance frequency among the search patterns “fo”, “or”, “wh”, “hi”, “il”, “le”, and “a” (step S14). Hereinafter, description will be given on assumption that the appearance frequency of the search pattern “il” is the lowest.

When it is determined that the number of obtained keywords is three, not one (No in step S15), the retriever 140 sets the search keyword “while” having the search pattern “il” whose appearance frequency is the lowest as a reference character string, and sets the keywords “for” and “a” which are not included in the reference character string “while” as verification character strings (step S18).

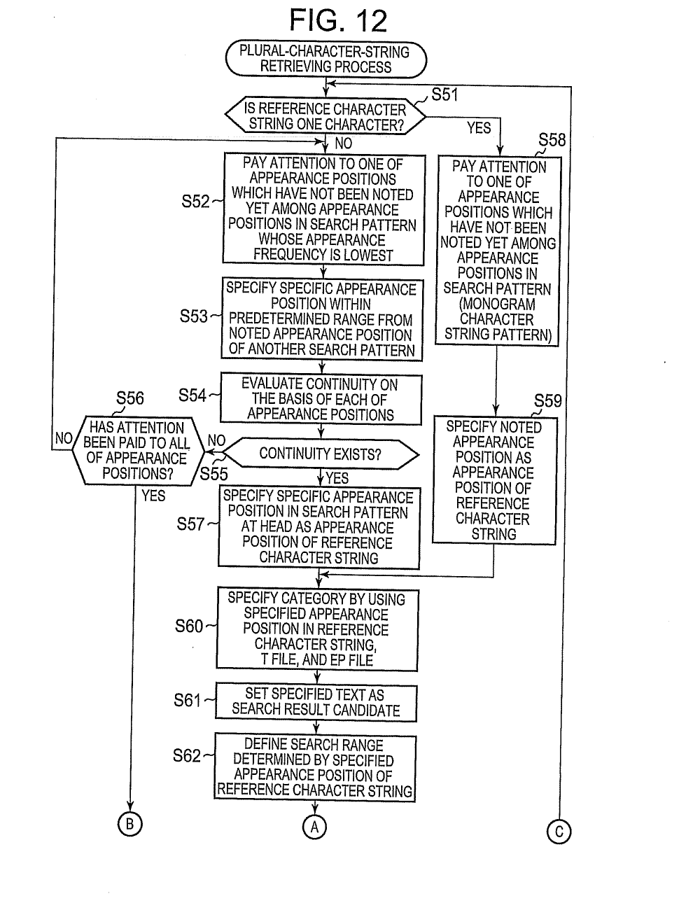

Next, the retriever 140 executes a plural-character-string retrieval process shown in FIG. 12 on the basis of the plurality of character strings “for”, “a”, and “while” (step S19).

When execution of the plural-character-string retrieval process shown in FIG. 12 is started, processes similar to those in steps S31 to S35 shown in FIG. 9 are executed for the reference character string “while” (steps S51 to S55).

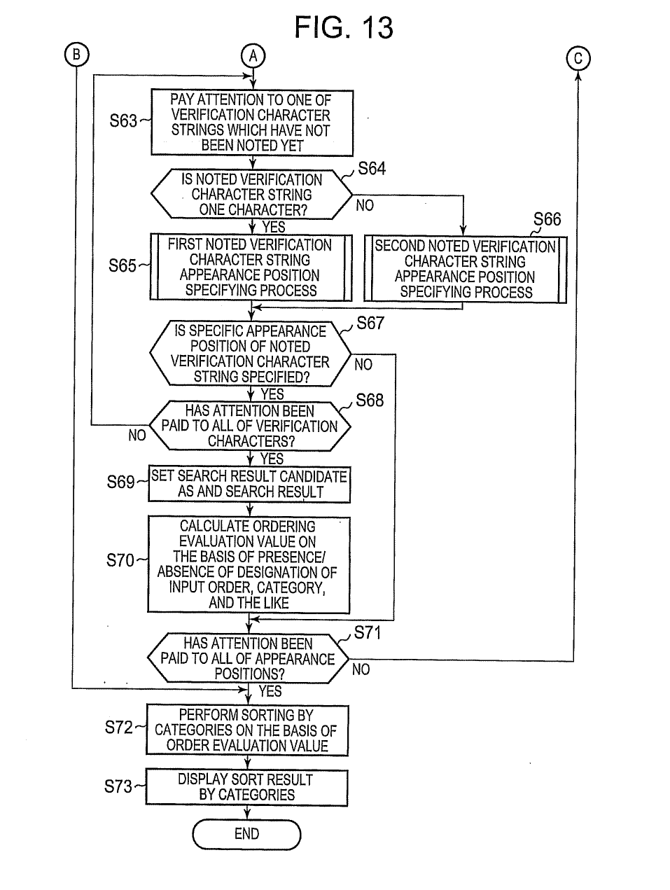

When the continuity evaluation result is determined as absence of continuity in step S55 (No in step S55), like in step S36, the retriever 140 determines whether attention has been paid to all of the appearance positions of the search pattern whose appearance frequency is the lowest or not (step S56). When it is determined that attention has not been paid to all of the appearance positions of the search pattern whose appearance frequency is the lowest (No in step S56), the retriever 140 repeats the processes from step S52. When it is determined that attention has been paid to all of the appearance positions of the search pattern whose appearance frequency is the lowest (Yes in step S56), the retriever 140 advances to step S72 shown in FIG. 13.

When the processes are repeated from step S52 and it is determined in step S55 that the continuity evaluation result is presence of continuity (Yes in step S55), the retriever 140 executes a process similar to that in step S37 (step S57).

When it is determined in step S51 that the reference character string is made by one character (Yes in step S51), the retriever 140 executes processes similar to those in steps S38 and S39 shown in FIG. 9 (steps S58 and S59).

By executing a process similar to that in step S40 shown in FIG. 9 after step S57 (or S59), the retriever 140 specifies a text in which the reference character string “while” appears in the noted appearance position (that is, specified text) and a category in which the text is sorted (that is, specified category) (step S60). After that, the retriever 140 sets the specified text as a candidate of a result of an AND search which is made with a plurality of search keywords (hereinafter, called search result candidate) (step S61).

The retriever 140 defines a predetermined range including the specified appearance position of the reference character string “while” as a search range (step S62). In the case where it is determined that all of verification character strings (that is, both “for” and “a”) appear in the search range by a process which will be described later, the search result candidate is used as a search result.

After that, the retriever 140 pays attention to the verification character string “a” which has not been noted yet among the verification character strings “for” and “a” (step S63). The verification character string “a” to which attention is paid will be called a noted verification character string.

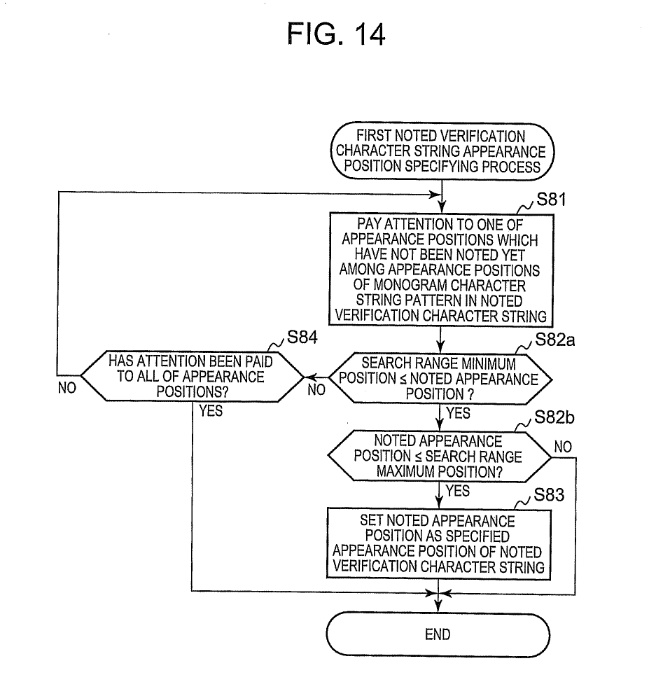

The retriever 140 determines that the noted verification character string “a” is made of one character (Yes in step S64) and executes a first noted verification character string appearance position specifying process shown in FIG. 14 (step S65).

The retriever 140 starts execution of the first noted verification character string appearance position specifying process, pays attention to an appearance position which has not been noted and is the first among the appearance positions of the monogram character string pattern in the noted verification character string “a” and sets the appearance position to which attention is paid as a noted appearance position (step S81). Subsequently, the retriever 140 determines whether or not the noted appearance position is included in the search range defined in step S62 shown in FIG. 12 (steps S82a and S82b shown in FIG. 14). When it is determined that the value of the address indicating the noted appearance position is not equal to or greater than the value of the address indicating the smallest position in the search range (No in step S82a), the retriever 140 determines whether or not attention has been paid to all of the appearance positions of the monogram character string pattern “a” of the noted verification character string (step S84). In the case where attention has not been paid to all of the appearance positions (No in step S84), the retriever 140 returns to step S81 and repeats the process.

After that, when the steps S81, S82a, and S84 are repeated and it is determined that attention has been paid to all of the appearance positions (Yes in step S84), the retriever 140 finishes execution of the first noted verification character string appearance position specifying process without specifying the specified appearance position of the noted verification character string.

When it is determined that the value of the address indicating the noted appearance position shows the smallest position in the search range (Yes in step S82b), the retriever 140 determines whether the value of the address indicative of the noted appearance position is equal to or less than the value of the address indicating the largest position in the search range (step S82b). When it is determined that the value of the address indicating the noted appearance position is greater than the value of the address indicating the largest position of the search range (No in step S82b), the retriever 140 determines that there is no appearance position included in the search range and finishes execution of the first noted verification character string appearance position specifying process without specifying the specified appearance position of the noted verification character string “a”.

After step S65 shown in FIG. 13, when it is determined that the specified appearance position of the noted verification character string “a” is not specified (that is, although the basic character string “while” is retrieved, “a” is not found in the search range) by execution of the first noted verification character string appearance position specifying process (No in step S67), the retriever 140 determines whether or not attention is paid to all of the appearance positions of the search pattern “il” whose appearance frequency is the lowest in the reference character string “while” (step S71). When attention has not been paid to all of the appearance positions (No in step S71), the retriever 140 repeats the processes from step S51 shown in FIG. 12.

After repeating the process while paying other appearance positions of the search pattern “il” whose appearance frequency is the lowest, the retriever 140 re-executes the first noted verification character string appearance position specifying process shown in FIG. 14 (step S65 shown in FIG. 13).

When the first noted verification character string appearance position specifying process is started, the retriever 140 pays attention to an appearance position which has not been noted and is the first in the search pattern “a” generated from the noted verification character string “a”, and sets the appearance position to which attention is paid as a noted appearance position (step S81). Subsequently, the retriever 140 determines whether or not the noted appearance position is included in the search range (steps S82a and S82b). When it is determined that the noted appearance position is included in the search range (Yes in steps S82a and S82b), the retriever 140 sets the noted appearance position as the specified appearance position of the noted verification character string “a” (step S83) and finishes execution of the first noted verification character string appearance position specifying process.

When it is determined in step S67 shown in FIG. 13 that the specified appearance position of the noted verification character string “a” is specified (that is, “a” is found in the search range using the specified appearance position of the basic character string “while” as a reference) by execution of the first noted verification character string appearance position specifying process (Yes in step S67), the retriever 140 determines whether attention has been paid to all of the verification character strings (step S68).

Since attention has been paid yet to the verification character string “for” at this stage, the retriever 140 returns to step S63 and sets the verification character string “for” as the noted verification character string (step S63).

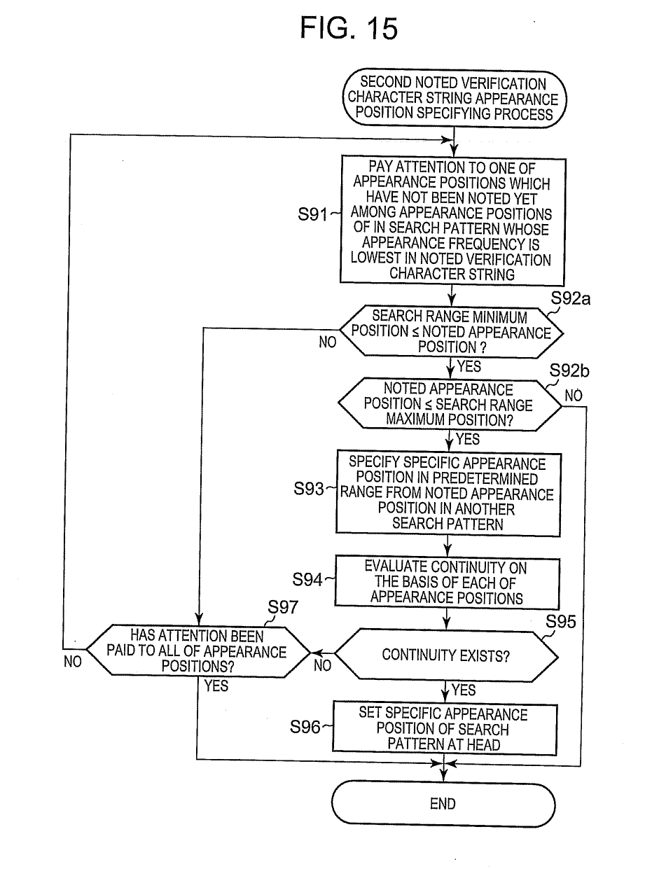

After that, the retriever 140 determines that the noted verification character string “for” is not made by one character (No in step S64), and executes a second noted verification character string appearance position specifying process shown in FIG. 15 (step S66).

The retriever 140 starts execution of the second noted verification character string appearance position specifying process and specifies a search pattern whose appearance frequency is the lowest among search patterns generated from the noted verification character string “for” on the basis of the appearance frequency of each of the search patterns obtained in step S14 shown in FIG. 8. In the embodiment, description will be given on assumption that the appearance frequency of the search pattern “fo” is the lowest. Next, the retriever 140 pays attention to an appearance position which has not been noted yet and is the first among the appearance positions of the search pattern “fo” whose appearance frequency is the lowest (step S91). An appearance position to which attention is paid will be called a noted appearance position, and a search pattern appearing in the noted appearance position will be called a noted search pattern.

After that, in a manner similar to steps S82a and S82b shown in FIG. 14, the retriever 140 determines whether or not the value of the address indicating the noted appearance position is equal to or greater than the value of the address indicating the smallest position in the search range and is equal to or less than the value of the address indicating the largest position in the search range (that is, whether the noted appearance position is included in the search range or not) (steps S92a and S92b). When the retriever 140 determines that the value of the address indicating the noted appearance position is not equal to or greater than the value of the address indicating the smallest position in the search range (No in step S92a) and also determines that attention has not been paid to all of the appearance positions of the bigram character string pattern “fo” (No in step S97), the retriever 140 returns to step S91 and repeats the process.

When it is determined that the value of the address indicating the noted appearance position is equal to or greater than the value of the address indicating the smallest position in the search range (Yes in step S92b), the retriever 140 determines whether or not the value of the address indicating the noted appearance position is equal to or less than the value of the address indicating the largest position in the search range (step S92b). The retriever 140 determines that the value of the address indicating the noted appearance position is greater than the value of the address indicating the largest position in the search range (No in step S92b), determines that there is no appearance position included in the search range, and finishes execution of the second noted verification character string appearance position specifying process without specifying the specified appearance position of the noted verification character string “for”.

After that, when the steps S91, S92a, and S92b are repeated and it is determined that the noted appearance position is included in the search range (Yes in steps S92a and S92b), the retriever 140 specifies an appearance position from the noted appearance position to a predetermined range within the appearance positions of another search pattern “or” in the noted verification character string “for” and sets the appearance position which is specified, as a specified appearance position (step S93).

The retriever 140 evaluates continuity between the specified appearance position of the search pattern “fo” and the specified appearance position of the noted search pattern “or” by a method similar to that in step S34 shown in FIG. 9 (step S94). In the case where it is determined that the continuity evaluation result is absence of continuity (No in step S95), the retriever 140 determines whether or not attention has been paid to all of the appearance positions of the search pattern “fo” whose appearance frequency is the lowest (step S97). When it is determined that attention has been paid to all of the appearance positions of the search pattern “fo” (Yes in step S97), the retriever 140 finishes execution of the second noted verification character string appearance position specifying process.

After step S66 shown in FIG. 13, when the retriever 140 determines that the specified appearance position of the noted verification character string “for” is not specified by execution of the second noted verification characteristic string appearance position specifying process (No in step S67), the retriever 140 determines whether or not attention has been paid to all of the appearance positions of the search pattern “il” whose appearance frequency in the reference character string “while” is the lowest (step S71). When it is determined that attention has not been paid to all of the appearance positions (No in step S71), the retriever 140 returns to step S51 shown in FIG. 12 and repeats the process.

The retriever 140 pays attention to another appearance position of the search pattern “il” whose appearance frequency is the lowest and repeats the process, thereby re-specifying the specified appearance position of the reference character string “while” and the specified appearance position of the verification character string “a” (step S65). After that, the retriever 140 sets the verification character string “for” as a noted verification character string and re-executes the second noted verification character string appearance position specifying process shown in FIG. 15 (step S66 shown in FIG. 13).

In the second noted verification character string appearance position specifying process, when the retriever 140 executes the processes from step S91 to step S94 and, after that, determines that the continuity evaluation result is presence of continuity (Yes in step S95), the retriever 140 sets the specified appearance position of the search pattern “fo” as the specified appearance position of the noted verification character string “for” (step S96), and finishes execution of the second noted verification character string appearance position specifying process.

When the retriever 140 executes the second noted verification character string appearance position specifying process after step S66 shown in FIG. 13 and determines that the specified appearance position of the noted verification character string is specified (Yes in step S67), the retriever 140 determines whether or not attention has been paid to all of the verification character strings (step S68).

When the retriever 140 determines that attention has been paid to all of the verification character strings (step S68), the retriever 140 sets the search result candidate specified in step S61 shown in FIG. 12 as a result of an AND search using the reference character string “while” and the verification character strings “for” and “a” (step S69). After that, by a process similar to step S41 shown in FIG. 9, the retriever 140 calculates an evaluation value of a specified text as a search result by a process similar to step S41 shown in FIG. 9 (step S70).

A method of calculating an evaluation value of a specified text will now be described.

When the specified category of the specified text is the entry word CE, the retriever 140 retrieves information expressing an order determining method “equation 4” associated with information indicating that the search keywords are “plural” and information indicating the specified category “entry word” from the determining method table shown in FIG. 10.

Next, the calculator 150 calculates the number of characters of the reference character string “while”, the first verification character string “for”, and the second verification character string “a” as five, three, and one, respectively. Subsequently, the calculator 150 calculates an evaluation value of the specified text by using the number of characters and the specified appearance positions of the reference character string “while”, the first reference character string “for”, and the second reference character string “a” for the following equation (4).

Est_{idxid,cgy}=Est_{idxid,0}=EstDist_{WithoutOrder}

EstDist_{WithoutOrder}=EstDist=max Pos−misPos

where
maxPos: upper limit value of range including all of search character strings in the case where all Dist_{stdstr,vfystrk} becomes the minimum
minPos: lower limit value of range including all of search character strings in the case where all Dist_{stdstr,vfystrk} becomes the minimum

$${Dist}_{stdstr , vfystrk} = \{ \begin{matrix}( {Pos}_{vfystrk} + {NumStr}_{vfystrk} ) - {Pos}_{stdstr} [ {Pos}_{stdstr} \leq {Pos}_{vfystrk} ] \\ ( {Pos}_{stdstr} + {NumStr}_{stdstr} ) - {Pos}_{vfystrk} [ {Pos}_{stdstr} > {Pos}_{vfystrk} ]\end{matrix}$$

where

EstDist: distance between search keywords
EstDist_{WithoutOrder}: distance between search keywords (in the case where input order is not considered)
Dist_{stdstr,vfystrk}: distance between reference character string and k-th verification character string
NumStr_{vfystrk}: the number of characters of k-th verification character string
NumStr_{stdstr}: the number of characters of reference character string
Pos_{vfystrk}: specified appearance position of k-th verification character string
Pos_{stdstr}: specified appearance position of reference character string

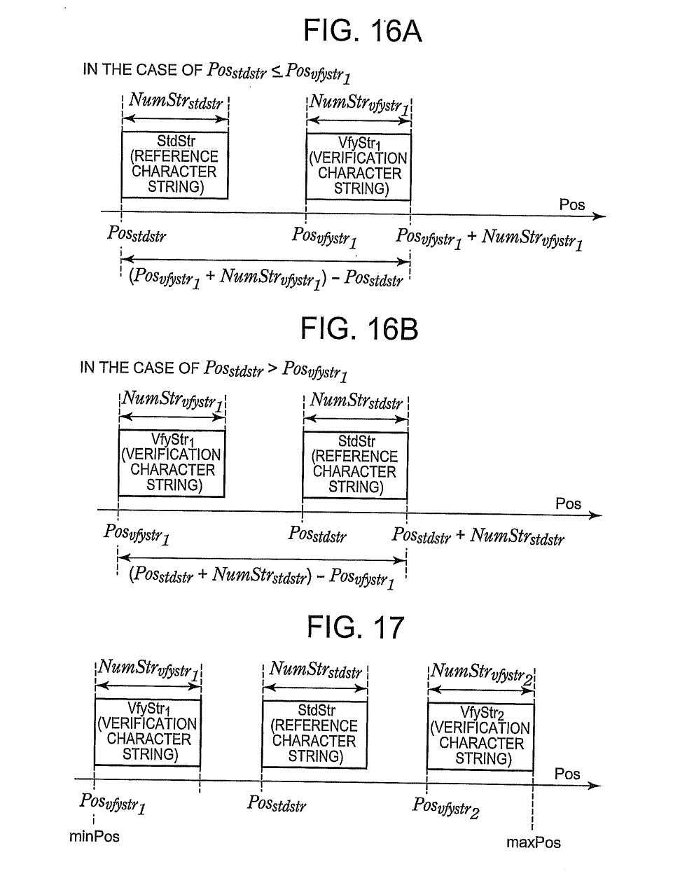

With respect to the distance between the reference character string and the k-th verification character string calculated by the equation (4), the distance between the reference character string “while” and the first verification character string “for” will be described as a concrete example. As shown in FIG. 16A, in the case where the specified appearance position of the reference character string “while” is before the specified appearance position of the verification character string “for”, the distance is from the head of the reference character string “while” to the end of the verification character string. On the contrary, as shown in FIG. 16B, in the case where the specified appearance position of the reference character string “while” is after the specified appearance position of the verification character string “for”, the distance is from the head of the verification character string “for” to the end of the reference character string “while”.

Next, with respect to the upper limit value maxPos and the lower limit value minPos calculated by the equation (4) and the distance between search keywords (without consideration of the input order) calculated using the upper and lower limit values, the reference character string “while”, the first verification character string “for”, and the second verification character string “a” will be described as concrete examples. As shown in FIG. 17, the upper limit value maxPos and the lower limit value minPos are the upper limit value and the lower limit value of a minimum range (hereinafter, called minimum including range) including all of a reference character string, a first verification character string “for” having the minimum distance to the reference character string “while”, and a second verification character string “a” having the shortest distance to the reference character string “while”. The distance between search keywords (in the case whe4re the input order is not considered) is the difference between the lower limit value minPos and the upper limit value maxPos.

In the case where the specified category of the specified text is the comment part CC, the retriever 140 retrieves information expressing the order determining method “equation 5” associated with information indicating that the search keywords are “plural” and information indicating the specified category “comment part” from the determining method table shown in FIG. 10.

Next, the calculator 150 calculates the distance between the search keywords and the lower limit value minPos in a manner similar to the case of calculating an evaluation value by using the equation (4). The calculator 150 also calculates the start position of the comment part CC corresponding to the specified entry word in a manner similar to the case of calculating the evaluation value by using the equation (2). After that, the calculator 150 calculates an evaluation value of a specified text by using the distance between the search keywords, the lower limit value minPos, and the start position of the comment part CC for the following equation (5).

$${Est}_{idxid , cgy} = {Est}_{idxid , 1} = {EstDist}_{WithoutOrder} + ( min Pos - {Pos}_{idxid , comentary} ) \qquad ( 5 )$$

In the case of comment texts in which the distance between the search keywords (without consideration of the input order) is the same, the closer the lower limit value minPos in a minimum inclusion range including the search keywords to the start position of the comment part CC is, the lower the evaluation value calculated by the equation (5) is. In the case of comment texts in which the distance between the lower limit value minPos and the start position of the comment part CC is the same, the shorter the distance between search keywords (without consideration of the input order) is, the lower the evaluation value calculated by the equation (5) is.

Next, in the case where the specified category of the specified text is the example part CX, the retriever 140 retrieves information expressing the order determining method “equation (6)” associated with the information indicating that the search keyboards are “plural” and information expressing the specified category “example part” from the determining method table shown in FIG. 10.

The calculator 150 calculates the difference between the search keywords and the lower limit value minPos in a manner similar to the case of calculating the evaluation value by using the equation (4) and calculates the start position of the example part in a manner similar to the case of calculating the evaluation value by using the equation (3). After that, the calculator 150 calculates an evaluation value of the specified text by using the distance between the search keywords, the lower limit value minPos, and the start position of the example text for the following equation (6).

$${Est}_{idxid , cgy} = {Est}_{idxid , 2} = {EstDist}_{WithoutOrder} + ( min Pos - {Pos}_{idxid , exaple , expid} ) \qquad ( 6 )$$

When the distance between the search keywords (without consideration of the input order) of a plurality of search keywords in the same arrangement order is the same, the closer the lower limit value minPos to the start position of the comment part CC is, the lower the evaluation value calculated by the equation (6) is. In the case of comment texts in which the distance between the lower limit value minPos and the start position of the example text is the same, the shorter the distance between search keywords (without consideration of the input order) is, the lower the evaluation value calculated by the equation (6) is.

After execution of step S70 shown in FIG. 13, when it is determined that attention has not been paid to all of the appearance positions of the search pattern “il” which is generated from the reference character string “while” and whose appearance frequency is the lowest (No in step S71), the retriever 140 returns to step S51 shown in FIG. 12, pays attention to another appearance position, and repeats the above processes.

After that, when it is determined in step S56 shown in FIG. 12 or in step S71 shown in FIG. 13 that attention has been paid to all of the appearance positions (Yes in step S56 or S71), the retriever 140 executes processes similar to those in steps S43 and S44 shown in FIG. 9 (steps S72 and S73) and finishes the plural-character-string retrieval process.

Next, using the case where two search keywords “while” and “*ing” are input before a search instruction is received as an example, the text retrieval process shown in FIG. 8 will be described again. “*ing” denotes a character string in which some characters exist just before the character string “ing”, and “*” is one of special characters and called a wildcard symbol.

When execution of the text retrieval process is started, the process in step S11 is executed. The retriever 140 determines that the special character “*” is included in the obtained search keyword “*ing” and deletes the special character “*” from the search keyword “*ing”. After that, the retriever 140 generates search patterns “wh”, “hi”, “il”, and “le” and search patterns “in” and “ng” from “while” and “ing” (step S12). By executing the processes in steps S12 to S18, “while” is set as a reference character string, and “*ing” is set as a verification character string. After that, the plural-character-string retrieval process shown in FIG. 12 is executed (step S19) and execution of the text retrieval process is finished.

When the plural-character-string retrieval process shown in FIG. 12 is started, processes in steps S51 to S66 are executed. When the second noted verification character string appearance position specifying process as shown in FIG. 15 is started in step S66, processes in steps S91 to S93 are executed. By the processes, “ng” is determined as a noted search pattern in the search patterns “in” and “ng” of the noted verification character string “*ing”.

After that, the retriever 140 specifies that the search pattern positioned immediately after the special character “*” is “in” and determines whether any character exists immediately before the specified appearance position of the search pattern “in”. When it is determined that no character exists immediately before the specified appearance position of the search pattern “in”, the retriever 140 evaluates that there is no continuity.

On the other hand, when the evaluation is presence of continuity, the retriever 140 re-evaluates continuity between the noted appearance position of the noted search pattern “ng” of the noted verification character string “*ing” and the specified appearance position of the another search pattern “in” by a method similar to that of step S34 in FIG. 9 (step S94). After that, the processes in steps S95 to S97 are executed and execution of the second noted verification character string appearance position specifying process is finished.

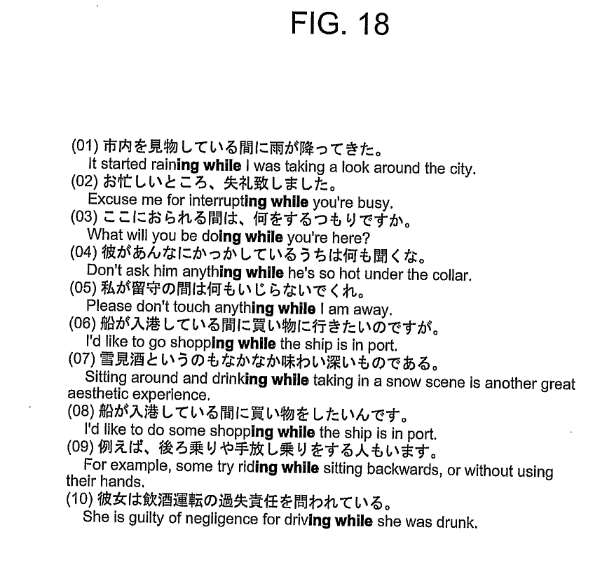

After the processes in steps S67 to S73 are executed subsequent to the step S66 shown in FIG. 13, execution of the plural-character-string retrieval process is finished. In step S73, the display 180 shown in FIG. 4 displays a plurality of example texts which are obtained by an AND search on the basis of the search keywords “while” and “*ing” and are of the first to tenth display order determined on the basis of the evaluation value calculated in step S70, in accordance with the display order as shown in FIG. 18.

For example, in the comment part CC of an electronic dictionary, comment texts are arranged according to the contents of the texts. For example, after a text describing the general meaning of an entry word, a text describing special meaning and a text describing meaning used in a specific field are arranged. With respect to example texts sorted in the example part CX of an entry word, for example, in an example text showing a general use example of a keyword or a use example of high use frequency, the keyword is often used in a position closer to the head. Since many users desire display of a text showing a general use example or a use example of high use frequency, the possibility that an example text in which a keyword is stored in a position closer to the head is a text desired by the user who entered the keyword is considered to be high.

Therefore, with the configurations, the appearance position associated with a character or character string constructing a search keyword, a text, a category, and a determining method are retrieved, and a text retrieved according to the output order determined by the retrieved determining method is output. Consequently, the results of retrieval of texts described in a plurality of categories on the basis of a search keyword can be rearranged by methods according to a plurality of categories, and the rearranged results can be output. Since the output order is determined by using the retrieved appearance position, the retrieved text is output in an order which is determined according to the text. Therefore, even when the number of retrieved texts increases, a text having content desired by the user is retrieved more easily.

For example, in the case where an idiom is constructed by a plurality of search keywords, it is considered that the shorter the distance between the plurality of search keywords constructing a text is, the more the text is desired by the user. Usually, words constructing an idiom are continuously used, and the user who enters a plurality of search keywords desires display of a text including the plurality of search keywords used as an idiom. Therefore, in the configurations, texts are output according to the order determined by using the distance between search keywords. Consequently, even when the number of texts retrieved increases, a text having content desired by the user is found more easily.

First Modification

In a first modification, the text search apparatus 100 displaying a text search result according to an input order of search keywords will be described.

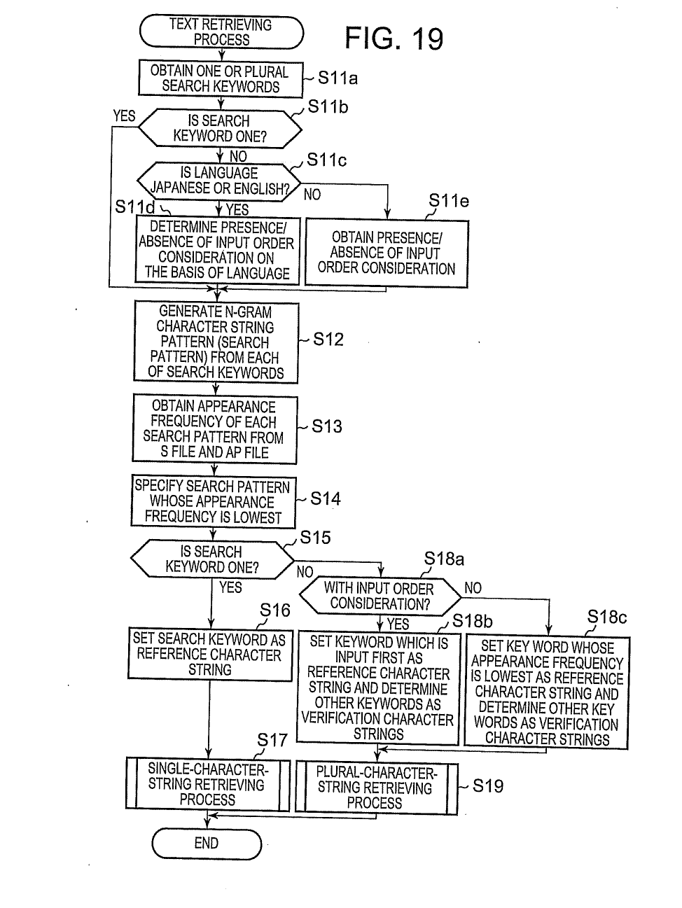

The text search apparatus 100 of the first modification executes text retrieval process as shown in FIG. 19 in place of the text retrieval process shown in FIG. 8. Hereinafter, the case where two search keywords “while” and “*ing” are entered before a search instruction is received will be described as an example.

When the text retrieval process shown in FIG. 19 is started, the obtainer 130 shown in FIG. 4 obtains the two search keywords “while” and “*ing” and then obtains a search instruction (step S11a).

The obtainer 130 determines that the number of obtained keywords is not one (No in step S11b). The determiner 160 shown in FIG. 4 determines whether the search keyword is a character string of English or Japanese (S11c). As a concrete example, the determiner 160 may determine the language of the character string as the search keyword on the basis of the value of predetermined bits of a character code expressing the search keyword. The retriever 140 may determine that the search keyword is a character string of English when the search keyword is constructed mainly by alphabets, and determine that the search keyword is a character string of Japanese when the search keyword is constructed mainly by “hiragana”, “katakana”, and “kanji” (kinds of Japanese characters).

When the determiner 160 determines that the search keyword is a character string of English in step S11c (Yes in step S11c), the obtainer 130 determines to display a search result in consideration of the input order of a plurality of search keywords (hereinafter, called “with consideration of the input order”) for the reason that when the order of a plurality of words differs, meaning of the words differs in many cases.

Subsequently, the processes in steps S12 to S15 described above are executed. After that, the retriever 140 determines that the search keywords are two search keywords “while” and “*ing” (No in step S15). The retriever 140 determines “with consideration of the input order” on the basis of step Slid (Yes in step S18a), sets the keyword “while” which is entered first as a reference character string, and sets the keyword “*ing” other than the reference character string as a verification character string (step S18b). The operation is performed so that the reference character string which is entered first is used as a reference and whether the verification character string appears in a position after the reference character string in accordance with the input order. Subsequently, the plural-character-string retrieval process shown in FIG. 12 is executed (step S19), and the execution of the text retrieval process is finished.

When the plural-character-string retrieval process shown in FIG. 12 is started, the above-described processes from step S51 to step S69 are executed. The retriever 140 calculates an evaluation value of a specified text as a search result of step S69 (step S70).

As a concrete example, in the case where a specified category of a specified text is the entry word CE, an evaluation value of the specified text is calculated by using the equation (4). In the case where a specified category of the specified text is the comment part CC, an evaluation value of the specified text is calculated by using the equation (5).

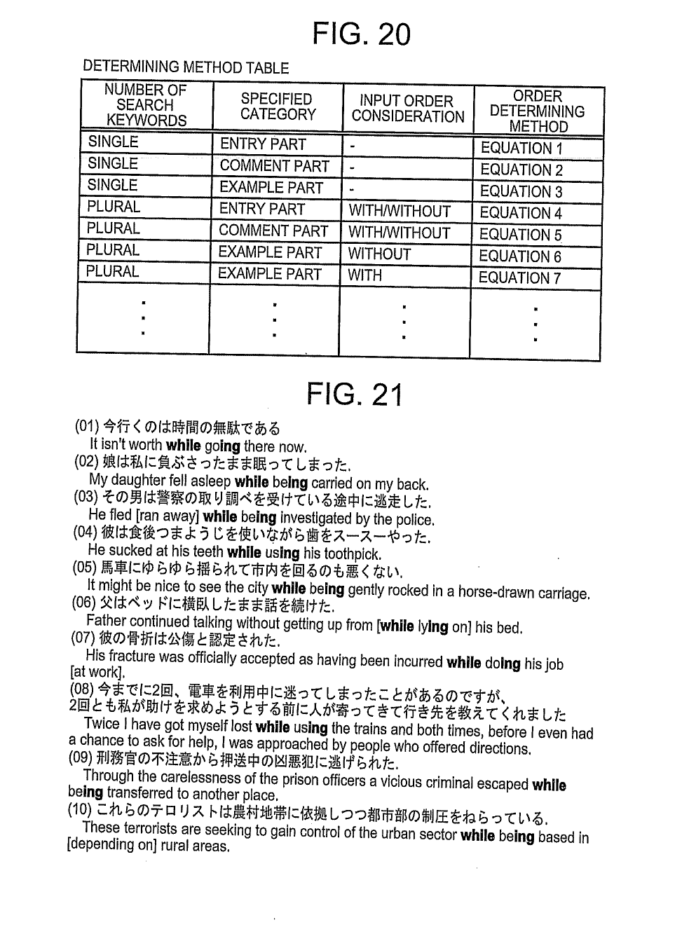

Further, in the case where a specified category of a specified text is the example part CX, the retriever 140 retrieves information expressing the order determining method “equation 7” associated with information indicating that search keywords are “plural”, information indicating the specified category “comment part”, and information indicating “with consideration of the input order” determined in step Slid shown in FIG. 19 from a determining method table shown in FIG. 20 in place of the determining method table shown in FIG. 10.

Next, the calculator 150 calculates the distance between the search keywords (without consideration of the input order) and the lower limit value minPos in a manner similar to the case of calculating an evaluation value by using the equation (4), and calculates the start position of the example text in a manner similar to the case of calculating the evaluation value by using the equation (3). After that, the calculator 150 calculates an evaluation value of a specified text by using the distance between the search keywords (without consideration of the input order), the lower limit value minPos, and the start position of the example text for the following equation (7).

$${Est}_{idxid , cgy} = {Est}_{idxid , 2} = {EstDist}_{WithOrder} + ( min Pos - {Pos}_{idxid , exaple , expid} ) \\ {EstDist}_{withOrder} = \{ \begin{matrix}EstDis [ {Pos}_{stdstr} < {Pos}_{{vfystrk}_{1}} < {Pos}_{{vfystrk}_{2}} … < {Pos}_{{vfystrk}_{M - 1}} ] \\ EstDis + valPENALTY ( other than the above condition )\end{matrix} \qquad ( 7 )$$

where
EstDist_{withOrder}: distance between search keywords (with consideration of input order)
M: the number of entries of search keyword

valPENALTY used in the equation (7) is a constant which is added to the distance between search keywords (without consideration of the input order) in the case where a verification character string is not arranged in input order after the reference character string as the search keyword which is entered first (that is, in the case other than the condition). valPENALTY is a positive number, and information indicative of the number is prestored in the information memory 110.

Like the evaluation value calculated by the equation (6), when the distance between search keywords (with consideration of the input order) in a plurality of search keywords in the same arrange order is the same, the closer the lower limit value minPos to the start position of the example text is, the lower the evaluation value calculated by the equation (7) is. In the case of comment texts in which the distance between the lower limit value minPos and the start position of the example text is the same, the shorter the distance between search keywords (with consideration of the input order) is, the lower the evaluation value calculated by the equation (7) is.

After the processes in steps S71 to S73 are executed subsequent to the step S70 shown in FIG. 13, execution of the plural-character-string retrieval process is finished. In step S73, the display 180 shown in FIG. 4 displays example texts of the first to tenth display order determined on the basis of the evaluation value calculated in step S70, in accordance with the display order as shown in FIG. 21.

The example texts shown in FIG. 21 include character strings corresponding to the search keywords “while” and “*ing” like the example texts shown in FIG. 18. However, different from the example texts shown in FIG. 18, the example texts shown in FIG. 21 are used in the search keyword input order. The ratio of texts including an idiom expressed by “while *ing” occupying in the example texts shown in FIG. 21 is higher than that of the example texts shown in FIG. 18. Therefore, the probability that the example texts shown in FIG. 20 are texts desired by the user who entered the search keywords “while” and “*ing” in order more than the example texts shown in FIG. 18 is considered to be high. The reason is that, usually, the user who enters a plurality of search keywords searches for use examples of an idiom used in the input order.

Usually, users desire that a text in which search keywords are arranged in the input order is displayed. Consequently, with the configurations, in the case where the arrangement order of the appearance positions of characters or character string retrieved is according to the search keyword input order, as the output order of retrieved texts, the above-described order is determined. Consequently, even when the number of texts retrieved increases, a text having content desired by the user is found more easily.

Next, using the case where two search keywords in Japanese are input before a search instruction is received as an example, the text retrieval process shown in FIG. 19 will be described again.

When execution of the text retrieval process is started, the processes in steps S11a and S11b are executed. Subsequently, the determiner 160 determines that the language of search keywords is Japanese (Yes in step S11c) and determines that a search result will be displayed without consideration of the input order of the plurality of search keywords (hereinafter, called “without consideration of input order”). The reason is that, in Japanese, different from English, even when the order of a plurality of words differs, meanings expressed by the words hardly differ.

After that, the processes in steps S12 to S15 are executed. Next, the retriever 140 discriminates the determination of “without consideration of input order” in step S11d (No in step S18a), sets a search keyword constructed by a search pattern whose appearance frequency is the lowest as the reference character string, and sets keywords other than the reference character string as verification character strings (step S18c) for the purpose of reducing the amount of calculation required for the search.

After execution of the plural-character-string retrieval process shown in FIG. 12 (step S19), the retriever 140 finishes execution of the retrieval process.

When the plural-character-string retrieval process shown in FIG. 12 is started, processes in steps S51 to S69 are executed. After that, the calculator 150 calculates an evaluation value of a specified text as a search result (Step S70).

As a concrete example, in the case where a specified category of a specified text is the entry word CE, an evaluation value of a specified text is calculated by using the equation (4). In the case where a specified category of a specified text is the commentary part CC, an evaluation value of a specified text is calculated by using the equation (5).

Further, in the case where a specified category of a specified text is the example part CX, the retriever 140 retrieves information expressing the order determining method “equation 6” associated with information indicating that search keywords are “plural”, information indicating the specified category “example part”, and information indicating “without consideration of the input order” determined in step S11d shown in FIG. 19 from the determining method table shown in FIG. 20. Subsequently, the calculator 150 calculates an evaluation value of a specified text by using the equation (6).

After that, the processes in steps S71 to S73 are executed, and execution of the plural-character-string retrieval process is finished.

Next, using the case where two search keywords in Korean are input before a search instruction is received as an example, the text retrieval process shown in FIG. 19 will be described again.

When execution of the text retrieval process is started, the processes in steps S11a and S11b are executed. Subsequently, the determiner 160 determines that the language of search keywords is neither English nor Japanese (No in step S11c). After that, the output unit 170 shown in FIG. 4 outputs a message asking entry of display designation for designating either display in which the input order of search keywords is considered or display in which the input order of search keywords is not considered to the display 180, and the display 180 displays the message.

When the user who sees the message operates the keyboard 100i to enter a display designation, the obtainer 130 obtains the display designation from the keyboard 100i. After that, the determiner 160 determines whether the input order is considered or not on the basis of the display designation (step S11e).

Subsequently, the processes in steps S12 to S19 are executed and, after that, execution of the text retrieval process is finished.

Second Modification

In the description of the embodiment, the calculator 150 shown in FIG. 4 calculates an evaluation value of an example text retrieved on the basis of the search keywords “while” and “ing” by using the equation (6). The present invention, however, is not limited to the case but the calculator 150 may calculate an evaluation value by using the following equation (8).

Specifically, the calculator 150 calculates the lower limit value minPos and the upper limit value maxPos in a manner similar to the case of calculating an evaluation value by using the equation (4) and counts the number EstCount of words existing in a range from the position indicated by the address of the calculated lower limit value minPos to the position indicated by the address of the calculated upper limit value maxPos. After that, the calculator 150 calculates an evaluation value of a specified text by using the counted number EstCount of words for the following equation (8).

Est_{idxid,cgy}=Est_{idxid,2}=EstCount (8)

where
EstCount: the number of words existing in range from minPos to maxPos

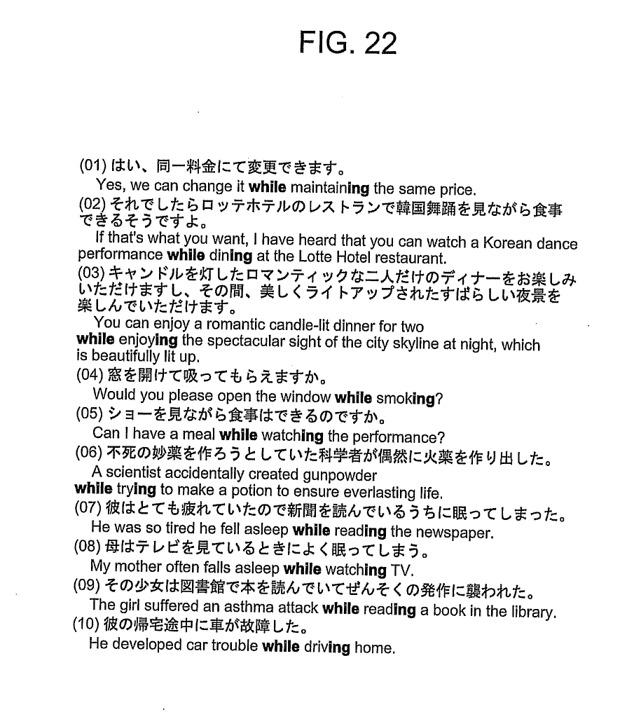

In this case, in step S73, the display 180 displays example texts of the first to tenth display order determined on the basis of the evaluation value calculated in step S70, in accordance with the display order as shown in FIG. 22.

The example texts shown in FIG. 22 include character strings corresponding to the search keywords “while” and “*ing” like the example texts shown in FIGS. 18 and 21. The example texts from the first to tenth display order shown in FIG. 21 include five texts each expressing a use example of “while being”. The reason is that the example texts from the first to tenth display order shown in FIG. 21 are texts whose display order is determined on the basis of the distance between search keywords.

In contrast, the example texts from the first to tenth display order shown in FIG. 22 are texts whose display order is determined on the basis of the number EstCount of words between the “while” character string and “ing”. Consequently, the example texts from the first to tenth display order are different use examples such as “while maintaining”, “while dining”, “while enjoying”, “while smoking”, “while watching”, “while trying”, “while reading”, and “while driving”. Therefore, the example texts of the first to tenth display order shown in FIG. 22 express use examples which are more various than the example texts of the first to tenth display order shown in FIG. 21, so that the probability that the example texts of the first to tenth order include texts desired by the users is considered to be high.

In the embodiment and the first and second modifications of the embodiment, the electronic dictionary may be a Japanese dictionary, an English-Japanese dictionary, a Japanese-English dictionary, or an encyclopedia. In the description of the embodiment and the first and second modifications of the embodiment, the text search apparatus 100 retrieves a dictionary on the basis of a search keyword. A document to be retrieved is not limited to a dictionary but may be any document as long as the document is constructed by a text sorted in a plurality of categories.

A document to be retrieved may be a patent specification constructed by texts sorted in categories such as “title of invention” and “scope of claims for patent”. In this case, the text search apparatus 100 may calculate an evaluation value of a text sorted in “title of invention” by using the equation (1) in the case where the number of a search keyword is one, and calculate an evaluation value by using the equation (4) in the case where the number of search keywords is two or more. Further, in this case, the text search apparatus 100 may calculate an evaluation value of a text sorted in “scope of claims for patent” by using the equation (2) in the case where the number of a search keyword is one, and calculate an evaluation value by using the equation (5) in the case where the number of search keywords is two or more for the following reason. Usually, a superordinate claim described in a position at or closer to the head is often a main claim, and matters considered by the inventor as special technical characteristics of the invention described in a patent specification are often written. In addition, in many cases, users desire display of a main claim considered by the inventor as special technical characteristics of the invention.

A document to be retrieved may be, for example, an explanatory document having a category in which texts expressing the name of a function of a product are sorted (hereinafter, called a function name category) and a category in which texts expressing an operation method for using the function are sorted (hereinafter, called an operation method category). In this case, the text search apparatus 100 may calculate an evaluation value of a text sorted in the function name category by using the equation (1) in the case where the number of a search keyword is one, and calculate an evaluation value by using the equation (4) in the case where the number of search keywords is two or more. Further, in this case, the text search apparatus 100 may calculate an evaluation value of a text sorted in the operation method category by using the equation (2) in the case where the number of a search keyword is one, and calculate an evaluation value by using the equation (5) in the case where the number of search keywords is two or more for the following reason. Usually, in many cases, an operation method of a function is described before a method including an incidental operation method for use of the function and a complicated operation method, and users desire display of an operation method necessary to use the function and the simplest operation method.

Although it is described in the embodiment that the full-text search by the N-gram method is used as a search keyword retrieval method, the search keyword retrieval method is not limited to the full-text search.

The embodiment of the present invention, the first modification of the embodiment, and the second modification of the embodiment can be combined with one another.

The text search apparatus 100 preliminarily provided with the configuration for realizing the function according to the embodiment, the first modification of the embodiment, or the second modification of the embodiment can be provided. Moreover, by applying a program, an existing text search apparatus can be made function as the text search apparatus 100 according to the embodiment, the first modification of the embodiment, or the second modification of the embodiment. That is, by applying a text search program for realizing functional configurations of the text search apparatus 100 according to the embodiment, the first modification of the embodiment, or the second modification of the embodiment so as to be executed by a computer (such as a CPU) controlling an existing text search apparatus, the existing text search apparatus can be made function as the text search apparatus 100 according to the embodiment, the first modification of the embodiment, or the second modification of the embodiment.

Such a program distributing method is arbitrary. For example, the program can be distributed by being stored in a recording medium such as a memory card, a CD-ROM, or a DVD-ROM or can be also distributed via a communication medium such as the Internet.

The present invention can be variously embodied and modified without departing from the spirit and scope of the present invention in a broad sense. Specifically, although some embodiments of the present invention have been described, the foregoing embodiments are for explaining the present invention but do not limit the scope of the present invention. The scope of the present invention is not limited to the embodiments but include the invention described in the scope of claims for patent and equivalents of the invention.

What is claimed is:

1. A text search apparatus comprising:
a memory storing a plurality of sets of text data, the text data of each set including a plurality of categories;
an obtainer obtaining a search keyword;
a retriever retrieving, for each category, text data including the obtained search keyword, from the text data stored in the memory; and
an output unit determining an order of outputting of the text data retrieved by the retriever with using an order determining method which is preliminarily determined in accordance with the category and outputting the retrieved text data category by category.

2. The text search apparatus according to claim 1, wherein the output unit also determines the order determining method in accordance with the number of search keywords obtained by the obtainer.

3. The text search apparatus according to claim 2, wherein the memory stores, as the text data, dictionary data in which the categories include an entry word category, and
the output unit determines the order of text data retrieved by the retriever in accordance with a proportion of the number of characters in the entry word category which coincide with the characters in the search keyword to the number of characters in the search keyword, as for the entry word category.

4. The text search apparatus according to claim 3, wherein the memory stores, as the text data, dictionary data in which the categories include a comment category, and
the output unit determines the order of text data retrieved by the retriever in accordance with an appearance position of a search keyword in comments in the comment category.

5. The text search apparatus according to claim 4, wherein the memory stores, as the text data, dictionary data in which the categories include a use example category, and
the output unit determines the order of text data retrieved by the retriever in accordance with an appearance position of a search keyword in the use examples in the use example category.

6. The text search apparatus according to claim 2, further comprising a calculator calculating a distance between search keywords in the text data retrieved by the retriever in the case where a plurality of search keywords are entered,
wherein the output unit determines the order based on an order determining method using the calculated distance.

7. The text search apparatus according to claim 1, further comprising an index memory storing N-gram character strings contained in the text data in the memory and an appearance positions of each of the N-gram character strings in the text data stored in the memory,
wherein the retriever retrieves the N-gram character strings on the basis of the search keyword, and performs a full-text search on the text data stored in the memory with reference to the index memory, and
the output unit discriminates the category whose text data contains the search key word, on the basis of the appearance positions, of the N-gram character strings retrieved by the retriever, in the text data.

8. A method of retrieving desired text data from a plurality of sets of text data stored in a memory, the text data of each set including a plurality of categories, and outputting the retrieved text data, comprising the steps of
obtaining a search keyword;
retrieving, for each category, text data including the obtained search keyword from the text data stored in the memory;
determining an order of the retrieved text data with using an order determining method which is preliminarily determined in accordance with the category; and
outputting the retrieved text data in accordance with the determined order category by category.

9. The method according to claim 8, wherein in determination of the order, the order determining method is also determined in accordance with the number of search keywords obtained.

10. The method according to claim 9, wherein the memory stores, as the text data, dictionary data in which the categories include an entry word category, and
the order of text data retrieved in the retrieving step is determined in accordance with a proportion of the number of characters in the entry word category which coincide with the characters in the entry word to the number of characters in the search keyword, as for the entry word category.

11. The method according to claim 10, wherein the memory stores, as the text data, dictionary data in which the categories include a comment category, and
the order of text data retrieved in the retrieving step is determined in accordance with an appearance position of a search keyword in the comments in the comment category.

12. The method according to claim 11, wherein the memory stores, as the text data, dictionary data in which the categories include a use examples category, and
the order of text data retrieved in the retrieving step is determined in accordance with an appearance position of a search keyword in the use examples in the use example category.

13. The method according to claim 9, further comprising a step of calculating a distance between search keywords in the text data retrieved in the retrieving step in the case where a plurality of search keywords are entered,
wherein the order is determined based on an order determining method using the calculated distance.

14. The method according to claim 8, wherein index data made of an N-gram character strings contained in the text data in the memory and an appearance positions of each of the N-gram character strings in the text data is stored in the memory,
N-gram character strings are retrieved on the basis of the search keyword, and a full-text search on the text data stored in the memory is performed with reference to the index data, and
in determination of the order, the category whose text data containing the search key word is determined on the basis of the appearance position, of the N-gram character strings in the text data.

15. A storage medium storing a program for retrieving desired text data from a plurality of sets of text data stored in a memory, the text data of each set including a plurality of categories, and for outputting the retrieved text data, the program making a computer execute the steps of
obtaining a search keyword;
retrieving, for each category, text data including the obtained search keyword from the text data stored in the memory;
determining an order of the retrieved text data with using an order determining method which is preliminarily determined in accordance with a category; and
outputting the retrieved text data in accordance with the determined order category by category.

16. The storage medium according to claim 15, wherein in determination of the order, the order determining method is also determined in accordance with the number of search keywords obtained.

17. The storage medium according to claim 16, wherein the memory stores, as the text data, in which the categories include an entry word category, and
the order of text data retrieved in the retrieving step is determined in accordance with proportion of the number of characters in the entry word category which coincide with the characters in the entry words to the number of characters in the search keyword, as for the entry word category.

18. The storage medium according to claim 17, wherein the memory stores, as the text data, dictionary data in which the categories include a comment category, and
the order of comments retrieved by the retrieving step is determined in accordance with an appearance position of a search keyword in the comments in the comment category.

19. The storage medium according to claim 18, wherein the memory stores, as the text data, dictionary data in which the categories include a use examples category, and
the order of text data retrieved in the retrieving step is determined in accordance with an appearance position of the search keyword in the use examples in the use example category.

20. The storage medium according to claim 16, wherein a distance between search keywords in the text data retrieved in the retrieving step is calculated in the case where a plurality of search keywords are entered, and
the order is determined based on an order determining method using the calculated distance.
